(19) United States
(12) Patent Application Publication
(10) Pub. No.: US 2026/0286574 A1
(43) Pub. Date: Sep. 24, 2026

(54) DEVICE FOR EVAPORATING A LIQUID FROM A COLLAGEN FIBER

(71) Applicant: EMBODY, INC., Norfolk, VA (US)

(72) Inventors: Rohith Ramachandran Nair, Norfolk, VA (US); Amrita Dasgupta, Yorktown, VA (US); Nardos F. Sori, Virginia Beach, VA (US); Michael P. Francis, Norfolk, VA (US); Nathan Kemper, Madison, WI (US); Connor M. Donahue, Missoula, MT (US); Matthew B. Havener, Norfolk, VA (US)

(21) Appl. No.: 19/473,064

(22) PCT Filed: Apr. 5, 2024
(86) PCT No.: PCT/US2024/023392

§ 371 Date: Oct. 6, 2025

Related U.S. Application Data
(60) Provisional application No. 63/494,931, filed on Apr. 7, 2023.

(51) Int. Cl. D01D 10/06

(52) U.S. Cl. CPC D01D 10/06; D10B 2211/06

(57) ABSTRACT

An apparatus for evaporating a liquid from collagen fiber includes: a fiber formation system configured to form the collagen fiber; a fiber collection system configured to collect the collagen fiber from the fiber formation system; and a first fan configured to create an airflow between the fiber formation system and the fiber collection system and over a surface of the collagen fiber.

### CLAIM OF PRIORITY

This application claims the benefit of U.S. Provisional Patent Application Ser. No. 63/494,931, filed on Apr. 7, 2023, the benefit of priority of which is claimed hereby, and which is incorporated by reference herein in its entirety.

### STATEMENT REGARDING GOVERNMENTAL SUPPORT

The data presented in this application was supported at least in part by DARPA SBIR 140D0420C0005. The US government has certain rights in the invention.

### BACKGROUND

### 1. Field of the Disclosure

The present disclosure relates to a method for manufacturing collagen fibers and their incorporation into scaffolds and implantable biocompatible devices prepared with such fibers. In particular, the disclosure relates to a device and method for evaporating a liquid from extruded collagen fibers having superior mechanical strength, biocompatibility and immunological properties.

### 2. Description of Related Art

Collagen is a fibrous insoluble protein consisting of bundles of reticular fibrils. Collagen fibrils combine to form white, glistening, inelastic fibers that are the primary component of connective tissues, including skin, bone, ligaments, and cartilage.

Many efforts have been made to manufacture collagen-containing scaffold-like tissue for use in the body to replace damaged collagen body parts, including in particular ligaments and tendons. A manufactured collagen-containing tissue may be considered an implantable device. Such an implantable device may replace the damaged part directly or may serve to provide a scaffold to facilitate repair of, and eventually replace, damaged soft tissues. Such products function in a variety of challenging biomechanical environments in which multiple functional parameters need to be addressed. These parameters include, for example, compatibility with bodily tissue and fluids, strength, flexibility, durability, and biodegradability.

There is a need in the art for a system and method that addresses the shortcomings discussed above.

### SUMMARY

In one aspect, the present disclosure is directed to an apparatus for evaporating a liquid from collagen fiber, the apparatus comprises: a fiber formation system configured to form the collagen fiber; a fiber collection system configured to collect the collagen fiber from the fiber formation system; and a first fan configured to create an airflow between the fiber formation system and the fiber collection system and over a surface of the collagen fiber.

In another aspect, the present disclosure is directed to an apparatus for evaporating a liquid from collagen fiber, the apparatus comprising: a first support member; a plurality of first fans mounted on the first support member; a second support member; and a plurality of second fans mounted on the second support member, wherein the first support member and the second support member form a channel.

In another aspect, the present disclosure is directed to an apparatus for evaporating a liquid from collagen fiber, the apparatus comprising: a plurality of production assemblies disposed in parallel with one another, each production assembly comprising: a first support member comprising a plurality of first openings and a plurality of first ports disposed along a length of the first support member; a plurality of first fans mounted on the first support member over the first ports; a second support member comprising a plurality of second openings and a plurality of second ports disposed along a length of the second support member; and a plurality of second fans mounted on the second support member over the second ports, wherein each production assembly includes a channel formed between the first support member and the second support member thereof along the length of the first support member and the length of the second support member.

Other systems, methods, features, and advantages of the embodiments will be, or will become, apparent to one of ordinary skill in the art upon examination of the following figures and detailed description. It is intended that all such additional systems, methods, features, and advantages be included within this description and this summary, be within the scope of the embodiments, and be protected by the following claims.

### BRIEF DESCRIPTION OF THE DRAWINGS

The embodiments can be better understood with reference to the following drawings and description. The components in the FIGURES are not necessarily to scale, emphasis instead being placed upon illustrating the principles of the embodiments. Moreover, in the figures, like reference numerals designate corresponding parts throughout the different views.

FIG. 1 is a schematic flow diagram of an embodiment of producing a biopolymer collagen fiber;

FIG. 2 is a schematic view of an apparatus for manufacture of biopolymer collagen fibers, according to an embodiment;

FIG. 3 is a schematic view of an evaporation system, according to an embodiment;

FIG. 4 is a schematic plan view of the evaporation system, according to an embodiment;

FIG. 5 is a schematic side view of a support member of the evaporation system, according to an embodiment;

FIG. 6 is a schematic end view of a channel of the evaporation system, according to an embodiment; and

FIG. 7 is a schematic plan view of a channel of the evaporation system, according to an embodiment.

### DETAILED DESCRIPTION

Example embodiments provide systems and methods for producing a biopolymer fiber. The biopolymer fiber may be formed of a collagen source material. Telocollagen and atelocollagen are hydrogels that may function as the collagen source material. These hydrogels may be obtained from any collagen source tissue (bone, skin, and connective tissue, recombinants, jelly fish, etc.). Bio-acceptable polymers, such as silk fibroin; other types of collagen such as type II collagen; fibrin/fibrinogen; basement membrane proteins; hyaluronic acid, poly ethylene oxide, poly ethylene glycol, poly caprolactone, polyethylene, polyhydroxybutyrate, PDLA; PDLLA and high molecular weight PDLLA; PLGA; and blends thereof, may be blended with a collagen source material to form the biopolymer fiber.

As described herein, collagen can be dissolved in an acid solution to form a collagen solution, which may be used as the collagen source material. In one embodiment, the prepared collagen solution may be passed or injected at a first speed through one or more apertures formed in a spinneret having a first diameter with a first speed. The spinneret may be configured to enable the collagen solution to emerge from the slits as a plurality of slender filaments. The spinneret itself sits within a fiber-forming bath, such as a tank containing formation buffer. For purposes of this disclosure, the term “filament”, or fibrous line, refers to the acidified collagen solution that is being extruded but has not yet had sufficient exposure to the formation buffer to accumulate an exterior sheath and become a collagen fiber or sub-fiber.

The formation buffer of the disclosed embodiments is configured as an elongated vertical tank, and the emergence of the filaments from the apertures can be arranged to occur near or from the bottom of the vertical tank. Thus, as the filaments emerge, they are immersed in a reaction zone for a time and at speeds sufficient to form collagen sub-fibers, also referred to herein more simply “sub-fibers”. The buoyancy of the filaments and sub-fibers relative to the surrounding formation buffer may cause the filaments and sub-fibers to float upward toward the top of the vertical tank. These resultant sub-fibers can then be collected together at the top of the vertical tank and withdrawn. The sub-fibers may be collectively joined to form a single collagen fiber, which may be cross-linked and dried. The collagen fiber may be wet or damp when collected. In such cases, the sub-fibers may tend to stick to each other if they are allowed to touch, especially during collection. Thus, when the sub-fibers are gathered in a bundle and wound together the sub-fibers adhere to one another, forming the collagen fiber.

Any number of sub-fibers may be associated, whether twisted or not, to form a bundle, and bundles may be assembled into larger bundles of multiple fibers. For example, bundles may comprise between 2 sub-fibers and about 10,000 sub-fibers, or between about 4 sub-fibers and about sub-6,000 fibers, typically between about 8 sub-fibers and about 4,000 sub-fibers, and more typically between about 12 sub-fibers and about 2,000 sub-fibers. The bundles may be combined, by twisting or otherwise, to form larger bundles. Bundles that are combined need not have equal numbers of fibers. Bundles may be described by the number of fibers in the bundle. For example, a 5-fiber bundle may be called a penta-fiber; 8 fibers would produce an octa-fiber, and so on. In some embodiments, systems and equipment with other numbers of nozzles or extruders may be used to produce such bundles.

In various embodiments of the disclosure, collagen or collagen and other suitable biopolymers are made into biopolymer or collagen fiber. For ease of understanding, the features of the disclosure will be described as they relate to collagen fibers. However, collagen may be blended or combined with suitable biopolymers in various combinations and proportions to obtain fibers of the type disclosed herein. In addition, throughout the specification, steps that might typically be taken together during a typical manufacturing process, such as washing and drying or soaking and drying, may be taken, or repeated, as appropriate to achieve a desired result. For example, in an embodiment, a composition may be washed and dried before advancing to a next step. In some embodiments, the material may be passed through a vertical tank of formation buffer a second time before advancing to a next processing step. In other embodiments, a first washing or drying step may be optionally omitted. Thus, a material typically washed, then dried, may go directly to the drying step, and then moved on to a next processing step. The skilled practitioner can recognize circumstances under which steps may be repeated or eliminated.

In different embodiments, the constructs, such as scaffolds, made from the fibers, allow cellular ingrowth, that is, various types of cells from the animal tissue into which the fiber (and devices made from the fiber) is implanted will grow into the pores of the scaffold, preferably aligned with the fibers in the scaffold. Constructs and scaffolds comprise single layer and multi-layer articles that may be used as a substitute for a known repair feature, such as sutures used to re-attach body parts, for example opposing ends of a ruptured Achilles tendon. In addition to providing supporting structures for use in repairing torn or damaged tendons, embodiments of the disclosure are suitable in ligament repair as well. Thus, other exemplary ligaments for which the scaffolds or the present invention may be used to provide support include the ACL, MCL, PCL, UCL, and other human and animal ligaments. Other surgeries for which products of the disclosure are useful include superior capsular reconstruction as a treatment option for superior rotator cuff tears, and in particular for otherwise irreparable or difficult to repair partial or full tears. Similarly, a multi-layered sheet may be used to overlap a repair to strengthen it.

In particular, embodiments of the disclosure may be suitable for repair of ligaments, tendons, and other soft tissues of animals of all types. Collagen fibers of the disclosure may be used, for example, to reattach torn ligaments and tendons, even those with only a partial tear. Plural fibers also may be twisted, bundled, braided, interwoven, or otherwise arranged to improve a form factor that may be easier to work with or manipulate than a single fiber, for example during surgery. Improving the form factor may make it easier to locate a fiber or platform accurately. Other form factors may be constructed to serve as a reinforcement or internal brace for a torn natural body part. A brace connects from one bone to another bone to support a joint. Typically, a brace forms an isometric joint with restored biomechanics and the isometry of the native joint.

In embodiments of the disclosure, the fiber produced may be a biopolymer fiber comprising collagen. The biopolymer fiber has one or more of the following characteristics: (a) an ultimate tensile strength of between about 20 MPa to about 300 MPa; (b) a modulus of elasticity of between about 200 MPa to about 3,500 MPa; (c) a strain at break of between about 4 percent and about 12 percent elongation; (d) an average fiber diameter between about 16 μm and about 500 μm, or between about 75 μm and about 300 μm, or between about 120 μm and about 160 μm, after drying; and (e) at least maintains about 20-30% of its strength after soaking in biological fluid for about 1 hour. The fiber may exhibit an ordered, longitudinally-oriented structure, and the fiber allows infiltration of cellular growth. The manufactured biopolymer collagen fiber can be used to develop implantable biopolymer scaffolds for supporting repair of a soft tissue injury, or for repair or replacement for a human body part, where the scaffold comprises at least one biopolymer sheet comprising biopolymer fibers. The sheet can comprise fibers arranged in a typical way for convenience of handling during use. For example, a single fiber would be exceedingly difficult to use because of the small diameter. Thus, it can be necessary or appropriate to form scaffolds, or structures larger than a single fiber, to provide fiber-containing products suitable for repair or replacement of a body part. Thus, for example, it may be possible to braid several fibers together to form a strand comprising collagen fibers. Such a strand may be useful, for example, to over-sew a rupture in a ligament or tendon.

In embodiments of the disclosure, clinical-grade atelocollagen and telocollagen may be used to form microfluidics extruded collagen microfibers which then can be crosslinked with biological and benign crosslinkers such as glyoxal or DL-Glyceraldehyde (DLG). These cross-linked fibers demonstrated hydrated ultimate tensile strength of about 300 MPa and modulus over about 3 GPa, significantly stronger than 50 other crosslinking strategies tested and exceeding native human Achilles tendon and anterior cruciate ligament strength. Glyoxal cross-linked fibers further retained 50% of the initial load-bearing capacity through 3-6 months in culture. Collagen fibers implanted in rats demonstrated biocompatibility, promoted the production of new, host-generated aligned collagen growing along the fibers, and in the case of glyoxal crosslinking, promoted an elevated pro-regenerative M2 macrophage response. Embodiments of the disclosure demonstrate marked improvements in healing compared with other crosslinked fibers, making embodiments of the disclosure superior fibers for generating strong collagen sutures or use as a device for ligament, tendon, or other soft tissue repairs.

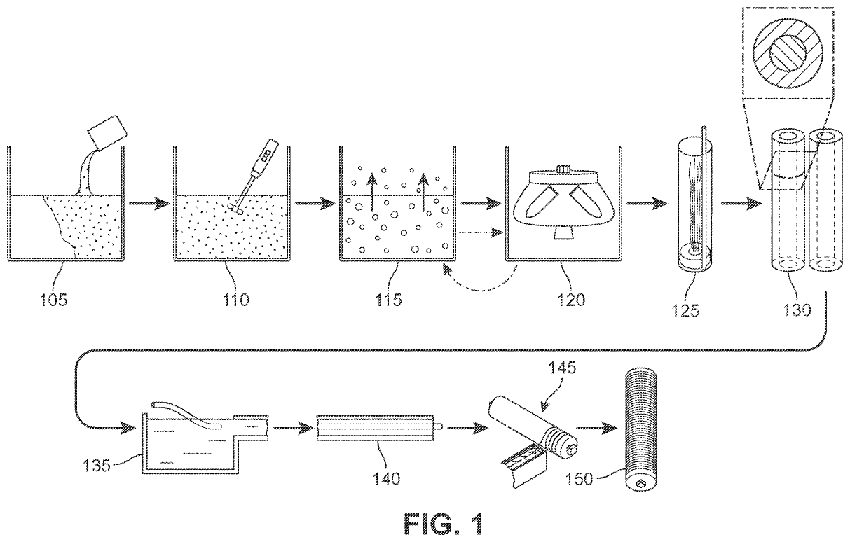

A system and method for manufacturing collagen fiber may be described as comprising sections or manufacturing areas. A collagen solution may be prepared in a first section, and collagen fiber may be formed in a second section. The collagen fiber may be collected in a third section and may be post-processed to yield wet or dry collagen fiber in a fourth section, post-treatment, or end of treatment. That is, steps in the system and method illustrated in FIG. 1 may be grouped into four categories, as follows:

| Category | Name | Steps Included |
|---|---|---|
| 1 | Preparing Collagen Solution | 105-120 |
| 2 | Forming Collagen Fiber | 125-130 |
| 3 | Collecting Collagen Fiber | 135-150 |
| 4 | Post-Treatment or End Treatment | Not shown |

As seen at step 105 of FIG. 1, collagen may be combined with an acidic solution and stirred thoroughly at step 110. In some embodiments, the acid may be between about 0.01 M and about 0.50 M acetic acid. In other embodiments, the acid may be between about 0.01 M and about 0.50 M hydrochloric acid. The solution may be degassed at step 115. The solution may be centrifuged at step 120 to remove residual bubbles. One or more of the steps 105-120 may be optionally omitted. For example, the centrifuge at step 120 may be optionally omitted.

Resultant collagen solution may be injected into a bath of formation solution as a stream of filaments to form a plurality of sub-fibers in step 125. The resultant forming sub-fibers may incorporate a coaxial sheath (shown in cross-section surrounding or encasing the filament) in step 130. This resultant product may be a formed collagen sub-fiber, which can be joined together to produce a collagen fiber. In different embodiments, the fiber may continue to a collection system, wherein the fiber may be passed through an optional alcohol immersion bath at step 135 and optionally dehydrated at step 140. The collagen fiber may be recovered at step 145 and collected on a spool and air-dried at step 150. Post-processing may be carried out on the recovered collagen fiber. Some examples of these techniques are described in further detail in U.S. Pat. No. 11,020,509 issued on Jun. 1, 2021 and titled “Microfluidic Extrusion” to Francis, et al. (hereinafter the Francis application), the disclosure of which is incorporated by reference herein in its entirety.

FIG. 1 is intended to provide a generalized view of a system and method for carrying out an embodiment of the disclosure. Additional details and disclosure are included in the following particular aspects and embodiments of the description below.

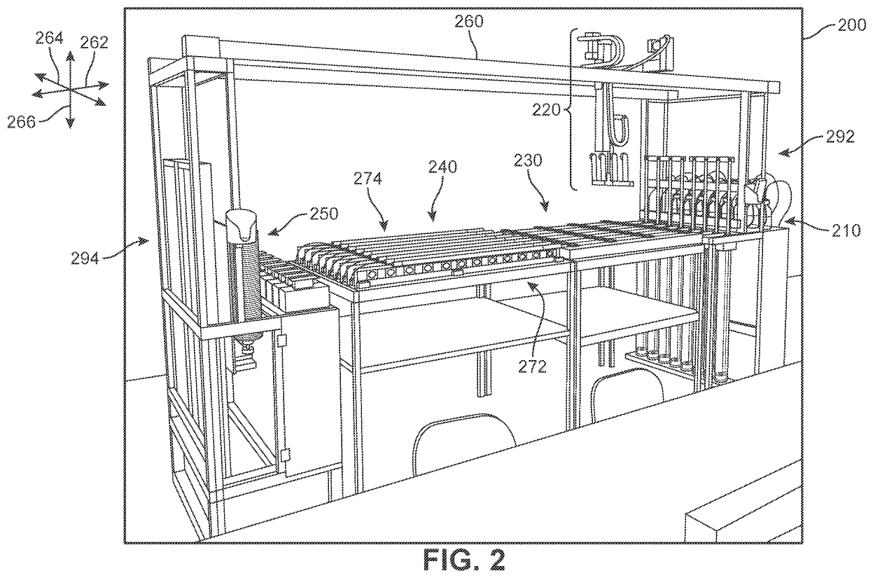

FIG. 2 introduces an embodiment of a collagen fiber manufacturing apparatus (“apparatus”) 200. In different embodiments, the apparatus 200 can be understood to include multiple interconnected systems, including a fiber formation system 210, a fiber pulley system 220, an alcohol immersion bath system 230, an evaporation system 240, and a fiber collection system 250. In one example, the systems are stabilized and held together by a framework 260. The following description will primarily discuss aspects and features related to the evaporation system 240.

Suitable arrangements and operations of the fiber formation system 210 are described in (172-MBDY-037), the entire disclosure of which is herein incorporated by reference. Furthermore, suitable arrangements and operations of the fiber pulley system 220 and the alcohol immersion bath system 230 are described in (172-MBDY-038), the entire disclosure of which is herein incorporated by reference. For clarity, the description makes reference to distal and proximal directions (or portions) in the context of the collagen fiber manufacturing apparatus 200. As used herein, the distal direction is a direction oriented away from the fiber formation system 210 and toward the fiber collection system 250, while the proximal direction is a direction oriented toward the fiber formation system 210 and away from the fiber collection system 250. The proximal and distal directions can also be understood to refer to opposing directions relative to a longitudinal axis 262 characterized in FIG. 2. Thus, the term “longitudinal” as used throughout this detailed description and in the claims refers to a direction extending between a proximal side 292 and a distal side 294 of the collagen fiber manufacturing apparatus 200.

Also, the term “lateral” as used throughout this detailed description and in the claims refers to a direction extending along a width of the collagen fiber manufacturing apparatus 200. In other words, the lateral direction may extend between a left side 272 and a right side 274 of the collagen fiber manufacturing apparatus 200, characterized by a lateral axis 264 in FIG. 2. Furthermore, the term “vertical” as used throughout this detailed description and in the claims refers to a direction generally perpendicular to a plane formed by the lateral and longitudinal directions. This may be characterized by a vertical axis 266 in FIG. 2 that extends in a direction between a top side and a bottom side of the apparatus 200. For example, in cases where a component has an end nearer a ground surface, the vertical direction may extend from the ground surface upward, such as along the length of each of the vertical tanks. Thus, each axis of the three axes may be understood to be orthogonal relative to the other two axes. Additionally, the term “inner” refers to a portion of a component disposed or enclosed by an outer surface, such as the interior chamber of the vertical tanks which hold the buffer. Likewise, the term “outer” refers to a portion of a component disposed further from the interior.

For purposes of clarity to the reader, embodiments may be characterized by various directional adjectives and reference portions. These directions and reference portions may facilitate in describing the portions of a system, components thereof, and/or the apparatus as a whole. Moreover, these directions and reference portions may also be used in describing each assembly of the apparatus (e.g., devices, mechanical components, and other structural features). Thus, for consistency and convenience, directional adjectives are employed throughout this detailed description corresponding to the illustrated embodiments.

As described herein, the collagen fiber is a collection of sub-fibers, gathered as a unitary bundle. In some embodiments, collagen fiber is wet or damp when collected after exiting the fiber formation system 210. In such cases, the sub-fibers may tend to stick to each other if they are allowed to touch, especially during collection. Thus, when the sub-fibers are gathered in a bundle and wound together the sub-fibers naturally adhere to one another, forming the collagen fiber.

According to one or more embodiments, the apparatus 200 aids in a drying of the collagen fiber produced by the fiber formation system 210. The process of drying may reduce a possibility of damaging the collagen fiber during subsequent handling. In some embodiments, the collagen fiber may be dried by exposure to an ambient environment as a collagen fiber transits from the fiber formation system 210 to the fiber collection system 250.

The ambient environment of the apparatus 200 may be a controlled environment in which characteristics such as temperature and humidity are controlled. The drying of the collagen fiber can be controlled according to the characteristics of the ambient environment. For example, increased temperatures may accelerate a rate of evaporation.

In some aspects, an airflow around and through the apparatus 200 may be controlled. For example, a direction and speed of the airflow may be controlled, where the speed of the airflow over the collagen fiber may affect the rate at which a liquid, such as water, evaporates off a surface of the collagen fiber. In some cases, a fan, blower, or compressor may be used to control the airflow. For example, a fan may be located above or next to the apparatus 200.

Drying processes can be generally divided into categories including convective or direct drying, which includes applying warmed air directly onto a material and drying externally, contact or indirect drying, which includes transferring heat through a surface to dry the material, dielectric drying, which uses radiation or radio waves to transfer heat into materials and dry the material internally, and air drying. Air drying may include exposure to an ambient environment and the application of unheated forced air in the ambient environment. One or more of these methods may be used by the apparatus 200 to remove water or other liquids from the collagen fiber.

The drying process may be performed in the ambient environment, with the aid of the alcohol immersion bath system 230, or with the aid of the evaporation system 240. The drying process may be performed with any combination of the ambient environment, the alcohol immersion bath system 230, or the aid of the evaporation system 240. For example, in some embodiments, the alcohol immersion bath system 230 and the evaporation system 240 are omitted and the collagen fiber may be dried in the ambient environment.

A distance that the collagen fiber transits in the ambient environment may be configured to achieve a desired amount of drying. For example, the fiber collection system 250 may be located adjacent to the fiber formation system 210. In other examples, the fiber formation system 210 and the fiber collection system 250 may be spaced apart by a few centimeters to several meters.

In some examples, one or more of the alcohol immersion bath system 230 and the evaporation system 240 may be disposed between the fiber formation system 210 and the fiber collection system 250. These components may have lengths in the longitudinal distance selected to achieve a desired amount of drying. Therefore, different lengths of the fiber formation system 210 and the fiber collection system 250 may be implemented. Further, the lengths of the fiber formation system 210 and the fiber collection system 250 may be the same or different.

In some embodiments, the collagen fiber may be maintained under tension by a tensioner as the fiber is dehydrated, and/or until the collagen fiber is wound on a collector of the fiber collection system 250. According to some aspects, as the collagen fiber may be spooled by the fiber collection system 250, it may be maintained at a desired tension or within a range of desired tension. The tension may be an induced tension due to the spooling of the fiber collection system 250. The tension may be controlled by the fiber collection system 250.

In some aspects, the collector of the fiber collection system 250 may be a grooved cylinder or spool. The grooved cylinder or spool may be a suitable collector, particularly for wet fibers. For example, a spool at the end of the system can be rotated at a speed that yields a draw speed for achieving a desired tension. In one example, the dried collagen fiber may be drawn onto a spool of the fiber collection system 250 at a speed faster than an injection speed of the prepared collagen solution, which may increase molecular alignment and reduce the diameter of the collagen fiber. The translational speed of the collector may be adjusted to adjust separation between collected fibers on the collector.

In some embodiments, the collagen fiber may be dried by exposure to an alcohol, which may bond with water in the collagen and aid in the generation of cross-links in the collagen. In some examples, the alcohol immersion bath system 230 includes an ethanol bath. As the collagen fiber passes through the ethanol bath, the collagen fiber may be immersed in ethanol. The ethanol may penetrate the collagen fiber and combine with water in the collagen fiber to form a mixture of ethanol and water (EtOH). In the mixture of ethanol and water, a hydrogen bond may be formed between a hydrogen group of the ethanol and the oxygen of a water molecule. The generation of the water-ethanol mixture may contribute to the formation of cross-links in the collagen.

In some aspects, the exposure to alcohol in the alcohol immersion bath system 230 strengthens the collagen. The strengthened collagen fiber may then be exposed to a gas environment for dehydration, which may further strengthen the collagen fiber. In one example, an emersion in alcohol prepares the collagen fiber for a subsequent exposure to a gas drying environment, which may include forced air drying and heating.

In a case where the alcohol immersion bath system 230 is implemented, the water-ethanol mixture may exhibit different characteristics depending on temperature. For example, the dielectric constant, viscosity, density, and hydrogen bonding effects may all vary with temperature. Accordingly, a temperature of the alcohol immersion bath may be controlled to control the characteristics of the water-ethanol mixture. Similarly, a temperature of the ambient environment may be controlled to control the characteristics of the water-ethanol mixture as the collagen exits the alcohol immersion bath system 230.

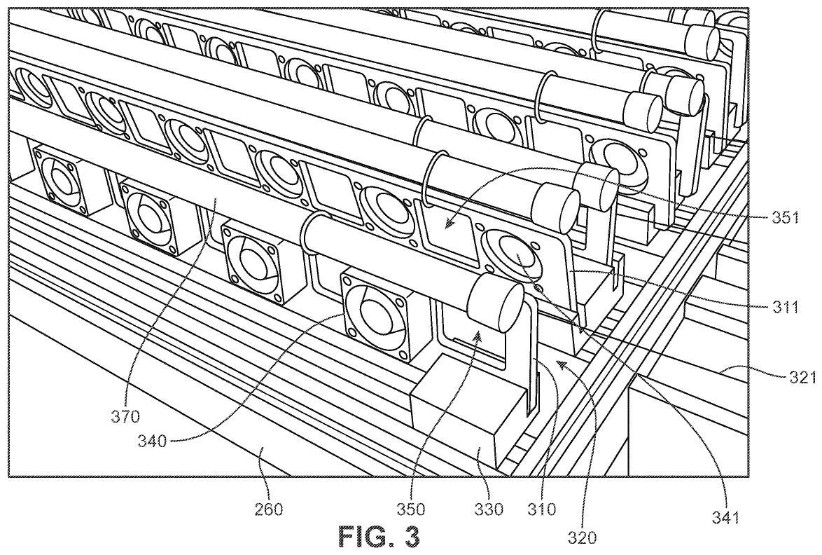

In some cases the evaporation system 240 may be implemented to aid in drying the collagen fiber. For purposes of clarity, FIG. 3 depicts an isolated view of an embodiment of the evaporation system 240. Once the collagen fiber is dried, the collagen fiber may be less likely to stick to already collected collagen fiber on the fiber collection system 250.

In some examples the evaporation system 240 includes a series of components. In general, the evaporation system 240 dries the collagen fiber. The evaporation system 240 may aid the evaporation of water from collagen fiber. The evaporation system 240 may also aid the evaporation of alcohol in the case that an alcohol immersion bath is implemented. At least in part, the evaporation action includes a drying portion. Drying can be understood as a process of using evaporation to remove water from liquids, gases, or solids. Drying can include removing water from a solution, a suspension, a solid-liquid mixture, or other material. That is, the principles of drying may be applied to any of a verity of materials or substances.

The evaporation system 240 may increase a dehydration rate of a liquid from the collagen fiber, whereby residual water may be removed from the collagen fiber. In some embodiments, the evaporation system 240 may increase a dehydration rate of a liquid from the collagen fiber by a forced convection, for example, using fans, blowers, or compressors.

According to some embodiments, the evaporation system 240 includes a plurality of support members and a plurality of fans attached to the support members. More generally, it can be observed in the drawings that the collagen fiber manufacturing apparatus 200 includes a repeating arrangement of components. For example, the evaporation system 240 can also be understood to comprise multiple, substantially identical, production assemblies. Each production assembly may include two opposing support members forming a channel through which a collagen fiber may transit from a proximal side and a distal side of the evaporation system 240. The collagen fiber manufacturing apparatus 200, by incorporating a greater number of assemblies, allows for mass production of collagen fibers, as well as the maintenance of a continuity of production in the case of errors or malfunction during operation of one of the assemblies.

For purposes of simplicity, the discussion herein will focus on a single production assembly of the evaporation system 240, with the understanding that there may multiple such assemblies working in concert, or side by side, in the collagen fiber manufacturing apparatus 200, as illustrated in FIG. 2. In FIG. 3, a first assembly can be understood to include a first support member 310 and a second support member 311 opposing the first support member 310. The first support member 310 and the second support member 311 form a channel 320, through which a collagen fiber 321 may transit in a longitudinal direction from a proximal side and a distal side of the evaporation system 240.

According to some embodiments, the evaporation system 240 dehydrates the collagen fiber 321, which may improve a quality and surface finish of the collagen fiber 321. The evaporation system 240 may include one or more fans, which may aid in the dehydration of the collagen fiber. For example, a fan may force an airflow around and through the apparatus 200 including over a surface of the collagen fiber 321. The fan may be used to control a direction and speed of the airflow. In some cases, a fan, blower, or compressor may be used to control the airflow. For example, a fan may be located above, below, behind, or next to the apparatus 200.

In a case where fans are arranged along the channel 320, the fans may be spaced apart from one another. In some cases, fans are not spaced apart and may be arranged directly next to each other, without a space, forming a group of fans along the channel 320. In at least one aspect, different groups of fans may be spaced apart. Spaces between fans or groups may be regular or irregular.

The first support member 310 may be disposed in or on a first base portion 330. In one embodiment, the first base portion 330 comprises a component, such as a grove, that supports the first support member 310. The first base portion 330 can be connected to the framework 260 by the first base portion 330. Additional base portions may be used to support the first support member 310 along its longitudinal length. In some aspects, the base portions may be omitted and the first support member 310 may be connected directly to the framework 260.

In some embodiments, the first support member 310 also supports a first fan 340 of the plurality of fans, and includes a first opening 350 of a plurality of openings. The openings may establish the spaces between fans. The openings may have various widths and heights. In one aspect, each adjacent pair of fans may be arranged with an opening therebetween. Therefore, the plurality of fans and the plurality of openings may be alternately arranged along the longitudinal length of the first support member 310. In another example, the fans may be grouped together, and groups of fans may be spaced apart by an opening. In yet another example, a number of openings may be disposed between two adjacent fans or two adjacent groups of fans.

The first support member 310 may support one or more fans. The fans may be disposed on either side of the first support member 310. The fans may be disposed on both sides of the first support member 310.

In one aspect, a plurality of support members supporting one or more fans are disposed along a side of the channel 320, replacing a single support member along a longitudinal length of the channel. In still another aspect, a support member configured without an opening may connect a fan to the framework 260, wherein for example, the support member is connected to a housing of the fan and does not block airflow through the fan. In some cases, fans may be attached directly to the framework 260 and the support member may be omitted. In still other examples, fans may be disposed independently of the apparatus 200.

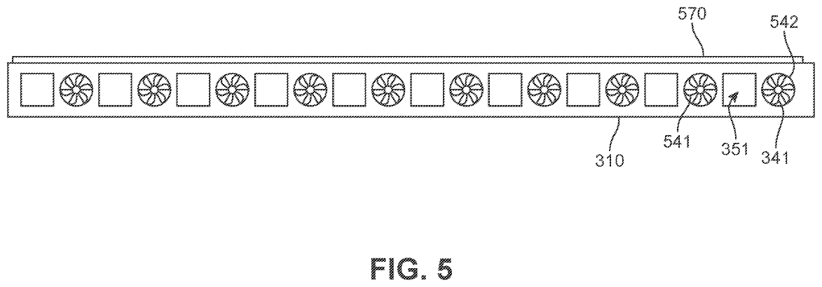

The second support member 311 may support a second fan 341 and include a second opening 351. Similar to the first support member 310, each adjacent pair of fans of the second support member 311 may be arranged with an opening therebetween. For example, as shown in FIG. 5, the second support member 311 may include the second fan 341 and a third fan 541 are separated by the second opening 351. Fans disposed on opposite sides of a channel may be variously arranged. For example, a fan on one side of the channel may be disposed directly across from another fan on an opposite side of the channel. In another example, fans may be disposed corresponding to openings across the channel. In still another example, fans across the channel may be offset from each other, with some portion of the fans overlapping each other.

According to some aspects, the second fan 341 of the second support member 311 opposes the first opening 350 of the first support member 310 directly across the channel 320. The first fan 340 of the first support member 310 opposes the second opening 351 of the second support member 311 directly across the channel 320. In some examples, each fan produces an airflow. According to some aspects, the airflow achieves a forced air convention, which aids in the dehydration of the collagen fiber 321.

In some aspects, the support members include ports disposed coincident with the fans, such that the fans may force air through the channel and over a surface of the collagen fiber. For example, as shown in FIG. 5, the second fan 341 may be mounted over a port 542 in the second support member 311.

The ports and openings of the support member may have various shapes. In some cases, the ports and openings may have rectangular shapes. In some example, the ports and openings may have round shapes. For example, as illustrate in FIG. 5, the ports may be round and the openings may be square. The ports and openings may have any shape.

According to some aspects, air of the ambient environment may be heated, that is conditions of the ambient environment may be controlled for temperature. In some cases, the air of the ambient environment may be dried such that the conditions of the ambient environment may be controlled for humidity. In some examples, the apparatus 200 may include a heater for warming the environment in which the collagen fiber is dried. In some cases, a heater may be attached to, or disposed near, a support member in order to increase a temperature of the air around the evaporation system 240.

In some embodiments, the first support member 310 includes a first heater 370 disposed on or above the fans. The first heater 370 may be disposed at any position that may increase a temperature of the air in and around the channel 320. For example, the first heater 370 may be connected directed to the framework 260.

The first heater 370 may increase a temperature of the air in and around the channel 320. The heated air may increase an effectiveness of the evaporation system 240. Similarly, as shown in FIG. 5, the second support member 311 includes a second heater 570 disposed on or above the fans.

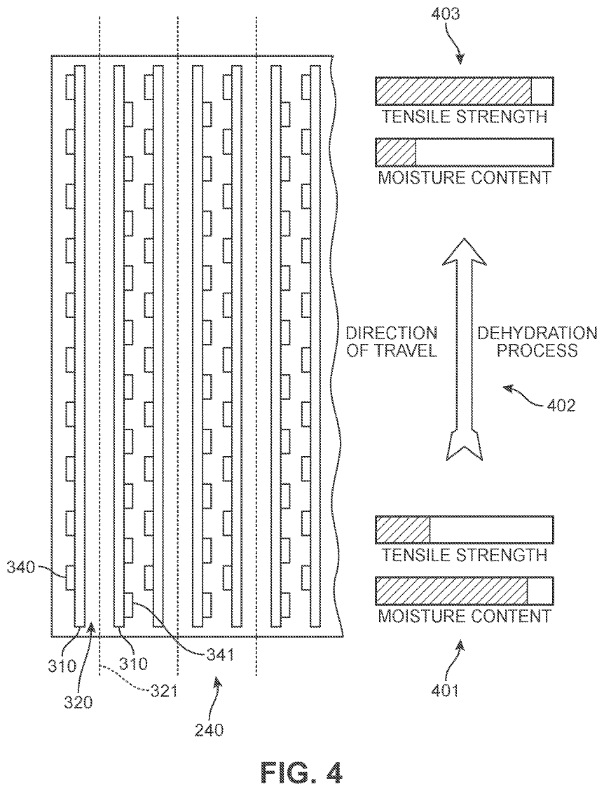

While the production assemblies have been described as being substantially identical, it should be noted that one or more of the production assemblies may differ. For example, the production assembly including the first support member 310 and the first base portion 330 includes only a single support member, while other base portions support a pair of support members. For example, as illustrated in FIG. 4, the production assembly including the first support member 310 and the first base portion 330 may be an end assembly disposed on a left-most position of the evaporation system 240.

FIG. 4 is a schematic plan view of the evaporation system, according to an embodiment. As shown in FIG. 4, the second fan 341 of the second support member 311 and the first fan 340 of the first support member 310 may be offset across the channel 320. Each support member may have any number of fans and any number of openings.

In at least one example, the collagen fiber 321 may be drawn through the evaporation system 240 by the fiber collection system 250. The fiber collection system 250 draws the collagen fiber 321 at a rate such that a given section of the collagen fiber 321 is within the channel 320 for a predetermined time. The rate may be selected based on, for example, a desired amount of evaporation from the collagen fiber.

Referring again to FIG. 4, entering the evaporation system 240, the collagen fibers have an initial condition with high moisture content and low tensile strength at 401. As any portion of the collagen fibers advances in the direction of travel it undergoes a dehydration process at 402, which may improve the tensile strength of that portion. Exiting the evaporation system 240, dehydrated portions of the collagen fibers may have lower moisture content and improved tensile strength at 403 due to the action of the evaporation system 240 as compared to the initial condition.

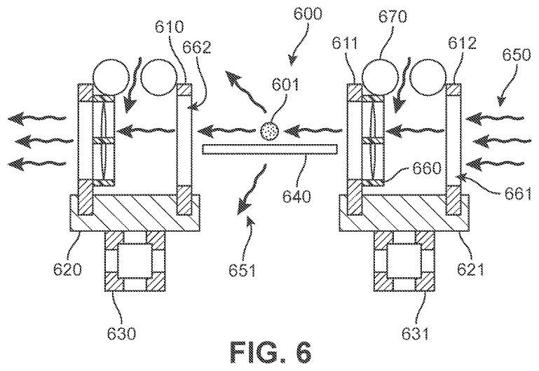

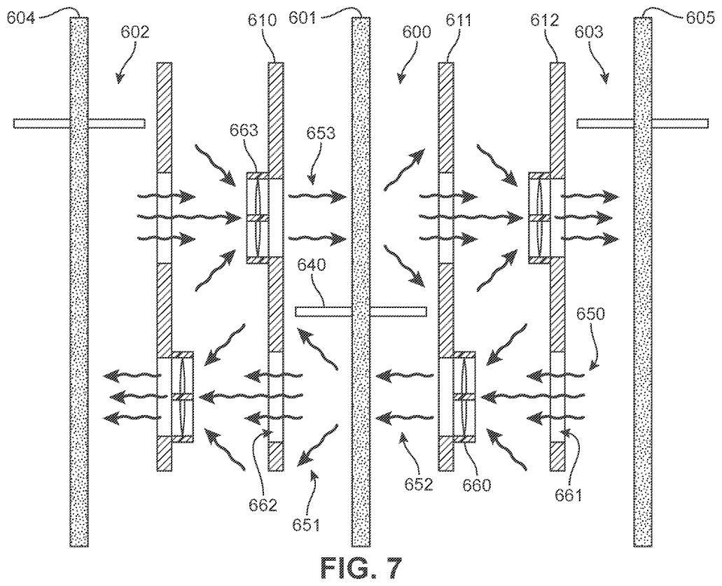

FIG. 6 is a schematic end view of a channel of the evaporation system, according to an embodiment. FIG. 7 is a schematic plan view of the channel of the evaporation system, according to an embodiment. A channel 600 may be formed between a left-side support member 610 and a right-side support member 611. A collagen fiber 601 may be pulled past a fourth fan 660 of the right-side support member 611. The collagen fiber 601 may be pulled by the fiber collection system 250. Portions of a length of the collagen fiber 601 may be supported by a guide rod 640. The guide rod 640 may be disposed horizontal to a ground surface, and perpendicular to a length of the channel 600 and a length of the collagen fiber 601. Support structures, such as the guide rod 640, may be independently supported by the framework 260 or components thereof. The guide rod 640 may ensure that the collagen fiber 601 is located within the channel 600 and exposed to the turbulent airflow therein.

The left-side support member 610 may be supported by a left-side base portion 620. The right-side support member 611 may be supported by a right-side base portion 621. The base portions are attached to the framework 260, which includes a first longitudinal frame portion 630 and a second longitudinal frame portion 631. Each base portion may support one or more support members. For example, the right-side base portion 621 supports the right-side support member 611 and a co-located support member 612. In some aspects, the support members may be perpendicular to the base portions. In other implementations the support members may be angled from the perpendicular, for example, about 5 to 10 degrees from the perpendicular (or vertical) as illustrated in FIG. 3.

According to some embodiments, support members co-located on a common base portion are arranged such that the fans of one support member are aligned with the openings of the other support member. For example, fourth fan 660 of the right-side support member 611 may be directly adjacent to opening 661 of the co-located support member 612. Thus, the airflow 650 may pass through the opening 661, be pulled by the fourth fan 660, and directed toward the collagen fiber 601 in the channel 600. Further, the fourth fan 660 of the right-side support member 611 directly opposes opening 662 of the left-side support member 610 across the channel 600.

At least because fans of opposing support members are offset from one another, an airflow in the channel 600 may be a turbulent airflow 651. The turbulent airflow 651 may improve the effectiveness of the evaporation system. As illustrated in FIG. 6, the channel 600 may be open above and below the collagen fiber 601. According to some aspects, the collagen fiber 601 vibrates in the turbulent airflow 651. The vibration of the collagen fiber 601 may be enhanced by opposing airflows, for example, a first airflow 652 exiting the fourth fan 660 and a second airflow 653 exiting a fifth fan 663. It can be observed that the first airflow 652 is in an opposite, and offset, direction to the second airflow 653, which may enhance the vibration on the collagen fiber 601. According to some aspects, the vibration of the collagen fiber 601 aids in shedding liquid from the collagen fiber 601.

As illustrated in FIG. 7, the channel 600 may be one channel of a plurality of channels. For example, the channel 600 may be disposed between a left-side channel 602 and a right-side channel 603. A left-side collagen fiber 604 may be dried in the left-side channel 602, while a right-side collagen fiber 605 may be dried in the right-side channel 603.

As illustrated in FIG. 6, a portion of the airflow passing by a heater 670 may be warmed. The heater 670 may increase a temperature of the air in and around the channel 600. The heated air may increase an effectiveness of the evaporation system 240 in drying the collagen fiber 601. That is, the airflow 650 may be warmed by the heaters of the evaporation system 240, which increases a capacity of the airflow to evaporate water and dry the collagen fiber 601.

As described herein, a spool at the end of the system can be rotated at a speed that yields a draw speed for achieving a desired tension in the collagen fiber. For example, the speed may be between about 2 times a fiber formation rate and about 4 times a fiber formation rate, or between about 2.5 times the fiber formation rate and about 3.5 times the fiber formation rate, or between about 2.75 and 3.25 the fiber formation rate. In one example, the dried collagen fiber may be drawn onto a spool of the fiber collection system 250 at a speed between about 2 and 10 times faster than an injection speed of the prepared collagen solution. A tension on the collagen fiber, induced by the fiber collection system 250 may increase molecular alignment within the collagen fiber and reduce a diameter of the collagen fiber.

The tension caused by the spooling of the fiber collection system 250 may be used to control a drop in the collagen fiber over at least a portion of its longitudinal length. The tension may also be used assist in controlling a thickness of the collagen fiber. For example, the tension may stretch the collagen fiber, resulting in a thinning of the collagen fiber. Further, the tension may be used to control a residual stress that may remain in the collagen fiber once the tension has been release, for example, once the collagen fiber is removed from the fiber collection system 250.

In some aspects, a drying process facilitated by the apparatus 200 may improve a quality and surface finish of the collagen fiber. In some embodiments, the drying process may also help to maintain consistent cross-sections (within a tolerance) and consistent properties throughout a length of the collagen fiber.

In some embodiments, the drying process may lead to the formation of cross-links in the collagen fiber. The cross-links in the collagen fiber may be intramolecular links between collagen molecules, and may be formed when water molecules are removed from the collagen. These intramolecular links can be amide bonds.

The evaporation system 240 may aid in strengthening the collagen fiber by the formation of cross-links in the collagen fiber. That is, crosslinking may be induced by the removal of water from the collagen fiber using the evaporation system 240. As described herein, the collagen fiber may be made stronger during the drying process due to increased crosslinking between collagen molecules of the collagen fiber as the water is removed. More particularly, a tensile strength of the collagen fiber may be increased as a moisture content of the collagen fiber is reduced, and cross-links are formed.

Tensile strength is a mechanical strength property. The tensile strength of a material defines a feasibility of deformation that the material can undergo with the application of a load. The tensile strength of collagen may be understood to be a maximum stress that the collagen can withstand before breaking when stretched or pulled. Tensile strength may be related to maximum stretch before a collagen material tears, for example, on a percentage basis.

Exemplary embodiments are also directed to producing collagen biopolymer fibers using the collagen fiber manufacturing apparatus with a drying function. The drying may be performed for a plurality of collagen fibers simultaneously through a plurality of collagen fiber treatment processes arrangement in parallel. Overall, this method provides for the simultaneous drying of a plurality of separate collagen fibers. The steps discussed above for single collagen fiber may be performed for each collagen fiber in the plurality of collagen fibers. In one embodiment, each one of a plurality of collagen fibers are drawn through an evaporation system, which may dry or partial dry the collagen fibers.

The processes and methods of the embodiments described in this detailed description and shown in the FIGURES can be implemented using any kind of computing system having one or more central processing units (CPUs) and/or graphics processing units (GPUs). The processes and methods of the embodiments could also be implemented using special purpose circuitry such as an application specific integrated circuit (ASIC). The processes and methods of the embodiments may also be implemented on computing systems including read only memory (ROM) and/or random access memory (RAM), which may be connected to one or more processing units. Examples of computing systems and devices include, but are not limited to: servers, cellular phones, smart phones, tablet computers, notebook computers, e-book readers, laptop or desktop computers, all-in-one computers, as well as various kinds of digital media players.

The processes and methods of the embodiments can be stored as instructions and/or data on non-transitory computer-readable media. The non-transitory computer readable medium may include any suitable computer readable medium, such as a memory, such as RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, magnetic disks or tapes, a read-only memory (ROM), a random access memory (RAM), a static random access memory (SRAM), a portable compact disc read-only memory (CD-ROM), an erasable programmable read-only memory (EPROM or Flash memory), electrically erasable programmable read-only memories (EEPROM), a digital versatile disk (DVD and DVD-ROM), a memory stick, other kinds of solid state drives, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

While various embodiments are described, the description is intended to be exemplary, rather than limiting and it will be apparent to those of ordinary skill in the art that many more embodiments and implementations are possible that are within the scope of the disclosed embodiments. Although many possible combinations of features are shown in the accompanying FIGURES and discussed in this detailed description, many other combinations of the disclosed features are possible. Any feature or element of any embodiment may be used in combination with or substituted for any other feature or element in any other embodiment unless specifically restricted. Further, unless otherwise specified, any step in a method or function of a system may take place in any relative order in relation to any other step described herein.

What is claimed is:

1. An apparatus for evaporating a liquid from collagen fiber, the apparatus comprising:
a fiber formation system configured to form the collagen fiber;
a fiber collection system configured to collect the collagen fiber from the fiber formation system; and
a first fan configured to create an airflow between the fiber formation system and the fiber collection system and over a surface of the collagen fiber.

2. The apparatus of claim 1, wherein the first fan is one of a plurality of first fans configured to create the airflow through the apparatus and over the surface of the collagen fiber.

3. The apparatus of claim 1, wherein the first fan is one of a plurality of first fans disposed on a first side of the collagen fiber, the apparatus further comprising a plurality of second fans disposed on a second side of the collagen fiber, the plurality of first fans and the plurality of second fans forming a channel between the fiber formation system and the fiber collection system.

4. The apparatus of claim 3, wherein an arrangement of the plurality of first fans and the plurality of second fans is configured to generate a turbulent airflow and vibrate the collagen fiber.

5. The apparatus of claim 3, further comprising:
a first support member comprising a plurality of first ports disposed along a length of the first support member, wherein the plurality of first fans are mounted on the first support member over the first ports; and
a second support member comprising a plurality of second ports disposed along a length of the second support member, wherein the plurality of second fans are mounted on the second support member over the second ports,
wherein the first support member and the second support member form the channel along the length of the first support member and the length of the second support member.

6. The apparatus of claim 5, wherein the first support member comprises a plurality of first openings disposed along the length of the first support member,
wherein the second support member comprises a plurality of second openings disposed along a length of the second support member, and
wherein the plurality of first fans of the first support member directly opposed the second openings of the second support member and the plurality of second fans of the second support member directly opposed the first openings of the first support member.

7. The apparatus of claim 3, further comprising a guide rod disposed in the channel and perpendicular to a length of the channel.

8. The apparatus of claim 1, further comprising a heater configured to warm the airflow between the fiber formation system and the fiber collection system and over the surface of the collagen fiber.

9. An apparatus for evaporating a liquid from collagen fiber, the apparatus comprising:
a first support member;
a plurality of first fans mounted on the first support member;
a second support member; and
a plurality of second fans mounted on the second support member,
wherein the first support member and the second support member form a channel.

10. The apparatus of claim 9, further comprising a guide rod disposed in the channel and perpendicular to a length of the channel, wherein the guide rod is configured to support the collagen fiber.

11. The apparatus of claim 9, further comprising a heater configured to warm air at a surface of the collagen fiber 1.

12. The apparatus of claim 9, further comprising:
a first heater disposed along a length of the first support member; and
a second heater disposed along a length of the second support member.

13. The apparatus of claim 9, wherein the plurality of first fans of the first support member directly the plurality of second fans of the second support member.

14. The apparatus of claim 9, wherein the plurality of first fans of the first support member are offset from the plurality of second fans of the second support member.

15. The apparatus of claim 9, further comprising a fiber collection system configured to pull the collagen fiber through the channel along a length of the channel.

16. The apparatus of claim 9, wherein an arrangement of the plurality of first fans and the plurality of second fans is configured to generate a turbulent airflow in the channel and vibrate the collagen fiber.

17. An apparatus for evaporating a liquid from collagen fiber, the apparatus comprising:
a plurality of production assemblies disposed in parallel with one another, each production assembly comprising:
a first support member comprising a plurality of first openings and a plurality of first ports disposed along a length of the first support member;
a plurality of first fans mounted on the first support member over the first ports;
a second support member comprising a plurality of second openings and a plurality of second ports disposed along a length of the second support member; and
a plurality of second fans mounted on the second support member over the second ports,
wherein each production assembly includes a channel formed between the first support member and the second support member thereof along the length of the first support member and the length of the second support member.

18. The apparatus of claim 17, wherein the plurality of first fans of the first support member directly opposed the second openings of the second support member within each production assembly, and
wherein the plurality of first fans of the first support member are offset from the plurality of second fans of the second support member within each production assembly.

19. The apparatus of claim 17, wherein an arrangement of the plurality of first fans and the plurality of second fans within each production assembly is configured to generate a turbulent airflow in the channel thereof.

20. The apparatus of claim 17, wherein an arrangement of the plurality of first fans and the plurality of second fans within each production assembly is configured to generate a turbulent airflow in the channel of each production assembly and vibrate a collagen fiber thereof.
